(19) United States
(12) Patent Application Publication
(10) Pub. No.: US 2024/0425157 A1
(43) Pub. Date: Dec. 26, 2024

(54) METHOD FOR DETERMINING AN EFFECT OF VARYING A PROPULSOR CHARACTERISTIC ON VESSEL PROPULSOR PERFORMANCE

(71) Applicant: A.P. Møller - Mærsk A/S, Copenhagen K (DK)

(72) Inventors: Shamba JUMAINE, Copenhagen K (DK); Mark Patrick EMBLETON, Copenhagen K (DK)

(21) Appl. No.: 18/827,275

(22) Filed: Sep. 6, 2024

Related U.S. Application Data
(63) Continuation of application No. PCT/DK2023/050039, filed on Mar. 7, 2023.

(30) Foreign Application Priority Data
Mar. 8, 2022 (DK) PA202200188

(51) Int. Cl. B63B 79/30; B63H 5/08; B63H 21/21

(52) U.S. Cl. CPC B63B 79/30; B63H 5/08; B63H 2021/216

(57) ABSTRACT

Disclosed is a method for determining an effect of varying a propulsor characteristic on vessel propulsor performance, the method comprising: obtaining information indicative of a performance property of a first propulsor of a vessel based on operation of the first propulsor for a first time period with a first variation of the propulsor characteristic; obtaining information indicative of the performance property of a second propulsor of the vessel based on operation of the second propulsor, simultaneous with the first propulsor, for the first time period with a second variation of the propulsor characteristic, wherein the second variation is different from the first variation; and determining a difference between the performance property of the first propulsor and the performance property of the second propulsor. Apparatus for determining an effect of varying a propulsor characteristic, and non-transitory computer-readable storage media, are also disclosed.

### CROSS-REFERENCE TO RELATED APPLICATIONS

This application is a continuation under 35 U.S.C. § 120 of International Application No. PCT/DK2023/050039, filed Mar. 7, 2023, which claims priority to Denmark Application No. PA202200188, filed Mar. 8, 2022 under 35 U.S.C. § 119(a). Each of the above-referenced patent applications is incorporated by reference in its entirety.

### FIELD OF THE INVENTION

The present invention relates to methods for determining an effect of varying a propulsor characteristic on vessel propulsor performance, apparatus for determining an effect of varying a propulsor characteristic on vessel propulsor performance, methods for determining performance properties of propulsors of a vessel, apparatus for determining performance properties of propulsors on a vessel, non-transitory computer-readable storage media, and vessels comprising said apparatus and/or non-transitory computer-readable storage media.

### BACKGROUND

The operation of a propulsor (e.g. an internal combustion engine) of a vessel is affected by propulsor characteristics. For example, the fuel efficiency of an internal combustion engine of a vessel depends on a variety of characteristics such as the type of lubricant supplied to the engine during operation, the type of fuel supplied to the engine during operation, and so on.

There is a need to be able to accurately determine the effect of varying a propulsor characteristic on the performance of a propulsor at sea so that beneficial propulsor characteristics can be identified and employed, thereby improving propulsor performance.

### SUMMARY

According to a first aspect of the present invention, there is provided a method for determining an effect of varying a propulsor characteristic on vessel propulsor performance, the method comprising: obtaining information indicative of a performance property of a first propulsor of a vessel based on operation of the first propulsor for a first time period with a first variation of the propulsor characteristic; obtaining information indicative of the performance property of a second propulsor of the vessel based on operation of the second propulsor, simultaneous with the first propulsor, for the first time period with a second variation of the propulsor characteristic, wherein the second variation is different from the first variation; and determining a difference between the performance property of the first propulsor and the performance property of the second propulsor.

Advantageously, operating two propulsors on the same vessel at the same time with variations of a propulsor characteristic allows for more accurate comparison of propulsor performance across variations of propulsor characteristics. For example, operating both propulsors on the same vessel at the same time means that both propulsors are subjected to the same external conditions during the test period (e.g. factors affecting the vessel as a whole, including weather- and time-based variations such as wind direction, wind speed, humidity, air temperature, and so on). Accordingly, an observed difference in propulsor performance properties between simultaneously-operated engines on the same vessel can more accurately be attributed to a predetermined difference between variations of propulsor characteristic, rather than factors external to the vessel.

In contrast, investigating the effect of a propulsor characteristic by operating a single propulsor under a first propulsor characteristic for a first time period, and then varying the propulsor characteristic of the single propulsor for a second time period, would mean that factors external to the operation of the propulsor itself (e.g. weather- and time-based variations such as wind direction, wind speed, humidity, air temperature, seawater temperature, wave conditions, sea conditions etc.) can change between the two test periods, meaning that direct comparison of the results cannot provide accurate quantification of the effect derived from varying the propulsor characteristic.

Further, obtaining information indicative of performance properties of propulsors based on operation of the propulsors on a vessel according to the present method may be more indicative of propulsor performance properties that are replicated on further operation of propulsors on other vessels at sea than, for example, results of investigations on varying propulsor characteristics of a propulsor in an onshore laboratory setting.

Investigations in a laboratory might typically involve operating a propulsor under a first propulsor characteristic for a first time period, and then varying the propulsor characteristic for a second time period. However, propulsors used in a laboratory setting are commonly scaled down compared with the propulsors employed onboard a vessel, such as a marine vessel. Scaled-down laboratory propulsors often have different thermodynamics. For example, scaled-down laboratory propulsors are not connected to a propeller which experiences resistance from the water during operation on a vessel, and/or scaled-down laboratory propulsors typically do not experience the physical conditions of a propulsor onboard a vessel at sea, such as air temperature and pressure. Further, laboratory propulsors are often simplified, and are not connected to the associated auxiliary equipment which is typically present onboard a vessel. Accordingly, the quantification of the effect derived from varying the propulsor characteristic according to the present method typically provides a more accurate indication of the effect of varying a propulsor characteristic onboard a vessel at sea than a corresponding quantification determined in a laboratory setting.

Optionally, the method further comprises attributing the difference between the performance property of the first propulsor and the performance property of the second propulsor to the difference between the first and second variations of the propulsor characteristic.

For example, the difference between the first and second variations of the propulsor characteristic might be the only controllable variable which differs between the operation of the first and second propulsor. In which case, the determined difference between the performance property of the first propulsor and the second propulsor can more accurately be attributed to the difference between the first and second variations.

Advantageously, attribution of the difference in performance property to the difference between the first and second variations of the propulsor characteristic can allow vessel operators to identify modifications to the operation of a propulsor onboard a vessel which will improve the performance property of propulsor(s) on a vessel.

Optionally, the method further comprises: obtaining information indicative of the performance property of the first propulsor of the vessel based on operation of the first propulsor for a second time period with the second variation of the propulsor characteristic; obtaining information indicative of the performance property of the second propulsor of the vessel based on operation of the second propulsor, simultaneous with the first propulsor, for the second time period with the first variation of the propulsor characteristic; and determining a difference between the performance property of the first propulsor during the second time period and the performance property of the second propulsor during the second time period.

For example, the propulsor characteristic variations are switched between the propulsors for the second time period. Advantageously, switching the propulsor characteristic variations between the propulsors for the second time period may at least partially reduce artefacts in the determining the difference in performance properties which derive from pre-existing differences between the first and second propulsor.

Optionally, the method further comprises determining the average (e.g. mean) of the differences in performance properties during the first time period and the second time period.

Optionally, the method further comprises: obtaining information indicative of (e.g., determining) the performance property of the first propulsor of the vessel based on operation of the first propulsor for a third time period with the first variation of the propulsor characteristic; obtaining information indicative of (e.g., determining) the performance property of the second propulsor of the vessel based on operation of the second propulsor, simultaneous with the first propulsor, for the third time period with the second variation of the propulsor characteristic; and determining a difference between the performance property of the first propulsor during the third time period and the performance property of the second propulsor during the third time period.

For example, the test conditions of the first time period are repeated for the third time period. Advantageously, performing a so-called “ABA” test protocol reduces (e.g. eliminates) artefacts in the determining the difference in performance properties which derive from differences in propulsor characteristics which are beyond operator control (e.g. varying wear in the propulsors, and/or pre-existing conditions of components of the propulsors such as clearances between components which are beyond operator control).

Optionally, the method further comprises determining the average (e.g. mean) of the differences in performance properties during the first time period, the second time period, and the third time period.

Optionally, the duration of the first time period is the same as the duration of the second time period. Optionally, the duration of the third time period is the same as the duration of the first time period and/or the second time period. Advantageously, the time periods being of the same duration can mean that a similar number of data points are obtained for each time period for improved comparison between the time periods.

Optionally, the determining the difference between the performance property of the first propulsor and the performance property of the second propulsor comprises performing statistical analysis of the information indicative of the performance property of the first propulsor and the information indicative of the performance property of the second propulsor.

Optionally, the performing statistical analysis comprises determining the normality of the information indicative of the performance properties, e.g. determining the extent to which the information has been drawn from a normally-distributed population. For example, the performing statistical analysis comprises performing a statistical normality test of the variables and residuals. In examples, the statistical normality test is one or more of: a Kolmogorov test; a Shapiro test; or an Anderson-Darling test. In examples, the statistical normally test is a Shapiro test.

Optionally, the performing statistical analysis comprises determining the variance homogeneity of the information indicative of the performance properties, e.g. determining the extent to which residual variance is homogeneous. For example, the performing statistical analysis comprises performing a homoscedasticity test (variance homogeneity test). In examples, the homoscedasticity test is a Breuscher test or a Levene test. In examples, the homoscedasticity test is a Levene test.

Optionally, the performing statistical analysis comprises determining a statistical significance of the determined difference between the performance properties. In examples, the determining the statistical significance comprises performing an independent samples t test.

Advantageously, performing statistical analysis can improve the accuracy of the determined difference between performance properties of the first propulsor and the second propulsor. For example, examples of methods where the determining the difference between performance properties comprises performing statistical analysis can provide determined differences with 0.5% accuracy, or 0.1%, accuracy, with statistical significance.

As used herein, “propulsor” refers to a device which, during operation, provides propulsion to the vessel or supplies motive power to another component which provides propulsion to the vessel. Optionally, each propulsor comprises a motor configured such that, during operation, the motor supplies motive power to one or more propellors of the vessel.

Optionally, each of the propulsors is an internal combustion engine. Optionally, each of the internal combustion engines is a two-stroke engine, such as a marine two-stroke engine. In examples, each of the internal combustion engines is a marine two-stroke crosshead engine.

Optionally, each of the propulsors is an electric motor. Optionally, the electric motor is configured to receive power from a fuel cell.

The method comprises determining a difference between the performance property of the first propulsor and the performance property of the second propulsor. Optionally, the performance property is efficiency of the propulsor.

Optionally, the performance property is airborne emission(s) from the propulsor. For example, the method allows for the determination of an effect of varying a propulsor characteristic on the airborne emission(s) of the propulsor. In examples, the performance property is airborne emission(s)-fuel efficiency (e.g. a ratio of the mass of emissions emitted from the propulsor during operation of the propulsor for the time period to the mass of fuel consumed during operation of the propulsor for the time period, at a given engine load), or airborne emission(s) efficiency (e.g. a ratio of the mass of emissions emitted from the propulsor during operation of the propulsor for the time period to the power output of the propulsor for the time period) or total airborne emission(s) (e.g. the mass of emission(s) emitted from the propulsor during operation of the propulsor for the time period). Advantageously, the performance property being airborne emission(s) can mean that a vessel operator can identify modifications which reduce airborne emissions from a vessel during operation of the vessel.

Optionally, the propulsor performance property is one or more of: filter smoke number, CO emissions, CO₂ emissions, NOₓ emissions, SOₓ emissions, VOCs emissions, particulate matter, or THC emissions.

Optionally, the performance property is energy conversion efficiency. For example, the method allows for the determination of an effect of varying a propulsor characteristic on the energy conversion efficiency of the propulsor. In this context, “energy conversion efficiency” refers to the ratio of energy consumed by the propulsor during operation (e.g. the chemical potential energy supplied to the propulsor, or the electrical energy supplied to the propulsor) to the energy output of the propulsor (e.g. work done in rotating a power shaft). Advantageously, the performance property being energy conversion efficiency can mean that a vessel operator can identify modifications which improve efficiency of operation of a vessel.

Optionally, energy is provided to the propulsor in the form of chemical potential energy; the propulsor consumes fuel to provide a propelling force. Optionally, the performance property is fuel efficiency. For example, the method allows for the determination of an effect of varying a propulsor characteristic on the fuel efficiency of the propulsor. In this context, “fuel efficiency” refers to the ratio of mass of fuel consumed by the engine to the power output of the engine over a period of time of operation, and may be expressed in terms of grams per kilowatt-hour (g/kWh). In examples, the performance property is the “Specific Fuel Oil Consumption” (SFOC) of the engine.

The method comprises determining an effect of varying a propulsor characteristic on vessel propulsor performance. As used herein, “propulsor characteristic” is a factor of the operation of the propulsor of which it is possible to make predetermined variations. For example, the propulsor characteristic is a factor in the operation of the propulsor which can (at least partially) be controlled by an operator of the propulsor. Optionally, the propulsor characteristic relates to a fluid in the propulsor, a component of the propulsor, an operating parameter of the propulsor, a component of propulsor ancillary equipment, or an operation parameter of propulsor ancillary equipment.

Optionally, the propulsor characteristic is one or more of: physico-chemical characteristic of fuel provided to the propulsor; physico-chemical characteristic of lubricant (e.g. lubricating oil) provided to the propulsor; volume of lubricant delivered to the propulsor; propulsor tuning; propulsor component material; propulsor component shape/size; propulsor component surface topography; arrangement of propulsor components; fuel delivery method; lubricant delivery method; configuration of propulsor ancillary equipment (e.g. turbocharger(s), cooling system(s)); exhaust gas treatment method; or particulate filters. Advantageously, examples of these propulsor characteristics can at least partially be controlled by an operator of a propulsor and/or the owner of the vessel.

Optionally, each propulsor is an internal combustion engine, and the propulsor characteristic is one or more of: physico-chemical characteristic of fuel provided to the propulsor; physico-chemical characteristic of lubricant (e.g. lubricating oil) provided to the propulsor; volume of lubricant delivered to the internal combustion engine; engine tuning; engine component material; engine component shape/size; engine component surface topography, arrangement of engine components; fuel delivery method; lubricant delivery method; configuration of engine ancillary equipment (e.g. turbocharger(s), cooling system(s)); exhaust gas treatment method; or particulate filters.

Optionally, the propulsor characteristic is the physico-chemical characteristic of the fuel or the physico-chemical characteristic of the lubricant.

Examples of physico-chemical characteristics of fuel include: sulfur content of the fuel, composition and proportion of hydrocarbons in the fuel (e.g. chain length), cetane number of the fuel, additives in the fuel, calorific value of the fuel, kinematic viscosity of the fuel, density of the fuel, atomization of the fuel upon delivery to the propulsor, temperature of the fuel upon delivery to the propulsor, and pressure of the fuel upon delivery to the propulsor.

Examples of physico-chemical characteristics of lubricant include: basicity (e.g. BN) of the lubricant, composition of the lubricant (e.g. species and/or proportion of additives, friction modifier additives and/or base oil present in the lubricant), shear stability of the lubricant, kinematic viscosity of the lubricant, viscosity index of the lubricant, temperature of the lubricant upon delivery to the propulsor, and pressure of the lubricant upon delivery to the propulsor. Optionally, the lubricant is cylinder oil, or system oil.

Typically, the method involves varying only one of these propulsor characteristics between the operation of the propulsors. For example, the method comprises obtaining information indicative of the fuel efficiency of a first internal combustion engine of a vessel based on operation of the first internal combustion engine for a first time period with a cylinder oil having a first kinematic viscosity; and obtaining information indicative of the fuel efficiency of a second internal combustion engine of the vessel based on operation of the second internal combustion engine, simultaneous with the first propulsor, for the first time period with a cylinder oil having a second kinematic viscosity, wherein the second kinematic viscosity is different from the first kinematic viscosity.

Optionally, the first time period is at least 24 hours (e.g. 1 day), at least 48 hours (e.g. 2 days), at least 7 days, or at least 14 days. Advantageously, a longer time period allows for obtaining a greater amount of information, thereby improving the accuracy of the determining the difference in propulsor performance properties. For example, examples of methods described herein provide an accuracy which allows for attribution of a 0.1% change in a propulsor operation parameter (such as fuel efficiency) to the difference between propulsor characteristics employed in the first and second propulsors.

Optionally, one or more of the first time period and/or second time period and/or third time period extends across a plurality of voyages. For example, the vessel may dock partway through a time period. Advantageously, examples of methods described herein can be performed during normal commercial operation of a vessel. For example, information indicative of the performance properties of the propulsors can be obtained without modifying the normal trading pattern of the vessel, such that performance of the method does not substantially negatively affect the vessel operator's normal business.

Optionally, the first time period comprises one or more portions of time during which the first and second propulsors are operated under steady state. As used herein “steady state” refers to operating conditions during which the propulsors can be operated in substantially the same way (excluding the predetermined differences between propulsor characteristic variations) and does not include, for example, periods of time during which the vessel is maneuvering or docking.

In examples, operating the propulsors under steady state comprises one or more of: operating the propulsors such that the speed and load of the propulsors is substantially constant (e.g. +/−3%); operating ancillary inputs and outputs equally across both propulsors; configuring gas flow management systems (e.g. valves, turbines, and so on) such that they are substantially constantly in predetermined defined states (e.g. no variation between opening and closing during operation at steady state); and configuring cooling systems and media such that they are substantially constantly in predetermined defined states.

In examples, the propulsors are operated under steady state such that: substantially stable forces are applied on the components of each propulsor; substantially stable speeds are obtained within the propulsors (e.g. stable linear or rotational speed); substantially stable pressures on, for example, fluids and components within the propulsors; and substantially stable temperatures of, for example, fluids and components within the propulsors.

Optionally, the first time period excludes one or more portions of time during which the first and second propulsors are not operated under steady state. For example, only information relating to the operation of the propulsors under steady state conditions is taken into account when determining the difference between the performance property of the first and second propulsors. Advantageously, determining propulsor performance property based only on operating of the propulsors at steady state reduces (e.g. eliminates) artefacts in the determining the difference in performance properties which derive from differences in varying operation of the propulsors.

Optionally, the second time period and/or third time period comprises one or more portions of time during which the first and second propulsors are operated under steady state. Optionally, the second time period and/or third time period excludes one or more portions of time during which the first and second propulsors are not operated under steady state.

Optionally the performance property is a first performance property, and the method further comprises: obtaining information indicative of a second performance property of the first propulsor based on operation of the first propulsor for the first time period with the first variation of the propulsor characteristic; obtaining information indicative of the second performance property of the second propulsor based on operation of the second propulsor, simultaneous with the first propulsor, for the first time period with the second variation of the propulsor characteristic; and determining a difference between the second performance property of the first propulsor and the second performance property of the second propulsor.

For example, the method can include analysis of a first performance property (e.g. efficiency, such as fuel efficiency) and a second performance property (e.g. airborne emission(s) from the propulsors). Advantageously, examples of the method can be performed to provide information on a plurality of propulsor performance properties.

Optionally, the determining the difference between the performance properties of the first and second propulsors is performed onboard the vessel. Alternatively, the determining is performed remote from the vessel. For example, the determining is performed onshore. Advantageously, performing the analysis remotely obviates the need for powerful computers onboard the vessel. Optionally, the method comprises communicating information indicative of the performance properties of the first and second vessel propulsor from onboard the vessel to a remote processor. Accordingly, the processor obtains information indicative of the performance properties of the first and second propulsors, and the processor performs the determining the difference between the performance property of the first propulsor and the performance property of the second propulsor. Optionally, the information is communicated in real-time, or near-real-time. For example, information is supplied from the vessel to the remote processor every 10 minutes.

Optionally, the vessel is a marine vessel, wherein the operating of the propulsors is performed at sea, and the analysis is performed onshore or otherwise remotely.

A second aspect of the present invention provides an apparatus for determining an effect of varying a propulsor characteristic on vessel propulsor performance, the apparatus configured to: obtain information indicative of a performance property of a first propulsor of a vessel based on operation of the first propulsor for a first time period with a first variation of the propulsor characteristic; obtain information indicative of the performance property of a second propulsor of the vessel based on operation of the second propulsor, simultaneous with the first propulsor, for the first time period with a second variation of the propulsor characteristic, wherein the second variation is different from the first variation; and determine a difference between the performance property of the first propulsor and the performance property of the second propulsor.

For example, there is provided an apparatus configured to perform a method according to the first aspect.

Optionally, the apparatus comprises a controller, the controller comprising a processor for performing the determining.

Optionally, the apparatus comprises a receiver for receiving the information indicative of the performance property of the first and second propulsors respectively. In examples, the receiver is a bus for receiving information from another component onboard a vessel. In examples, the receiver is a satellite receiver for receiving information transmitted from a transmitter onboard a vessel.

A third aspect of the present invention provides a non-transitory computer-readable storage medium storing instructions that, if executed by a processor, cause the processor to perform a method according to the first aspect.

A fourth aspect of the present invention provides a method for determining performance properties of propulsors of a vessel, the method comprising: operating a first propulsor of a vessel for a first time period with a first variation of a propulsor characteristic; operating a second propulsor of the vessel, simultaneous with the first propulsor, for the first time period with a second variation of the propulsor characteristic, wherein the second variation is different from the first variation; determining a performance property of the first propulsor based on the operation of the first propulsor; and determining the performance property of the second propulsor based on the operation of the second propulsor.

Features described in relation to the first aspect of the present disclosure are explicitly disclosed in combination with the fourth aspect, to the extent that they are compatible.

Optionally, the determining the performance properties of the first propulsor and second propulsor comprises obtaining information from one or more sensors for sensing (e.g. determining) the performance properties or for sensing (e.g. determining) properties corresponding to (e.g. proportional to) the performance properties. Optionally, the obtaining the information is performed by one or more controllers. In examples, the controller is onboard the vessel. Optionally, the controller is communicatively connected to each of the sensors such that the controller can obtain information from the one or more sensors. Optionally, the controller is configured to determine the performance properties based on the information received from the one or more sensors. For example, the controller is configured to determine the performance properties based on information indicative of properties corresponding to (e.g. proportional to) the performance properties.

Optionally, the propulsor performance property is fuel efficiency. Optionally, the determining the fuel efficiency of the first propulsor based on the operation of the first propulsor comprises: obtaining information from a first indicator for determining the power output of the first propulsor, obtaining information from a first inlet flowmeter for determining an amount of fuel supplied to the first propulsor, and optionally obtaining information from a first return flowmeter for determining an amount of fuel discharged from the first propulsor. The determining the fuel efficiency of the second propulsor based on operation of the second propulsor comprises: obtaining information from a second indicator for determining the power output of the second propulsor, obtaining information from a second inlet flowmeter for determining an amount of fuel supplied to the second propulsor, and optionally obtaining information from a second return flowmeter for determining an amount of fuel discharged from the second internal combustion engine.

Optionally, each flowmeter is a mass flowmeter. Advantageously, a mass flowmeter can provide more accurate information for determining the fuel efficiency of the engine than, for example, a volumetric flowmeter due to variation in density of the fuel during operation.

Advantageously, obtaining information from both an inlet flowmeter and a return flowmeter can allow for more accurate determination of the mass of fuel consumed by the engine during operation. For example, the controller is configured to determine the amount of fuel consumed by the engine during operation by determining the difference between the amount of fuel provided to the engine via the inlet flowmeter and the amount of fuel discharged from the engine via the return flowmeter.

Optionally, each of the first indicator and second indicator determines the power output of the first and second propulsors respectively by means of: fuel pump index method; load indicator method; PV diagram; or a shaft power meter.

Optionally, the first indicator is a first shaft power meter for determining the power output of the first propulsor, and the second indicator is a second shaft power meter for determining the power output of the second propulsor. Optionally, each shaft power meter comprises a dynamometer. Optionally, each shaft power meter comprises a torquemeter. Optionally, each shaft power meter comprises a torquemeter and/or a tachometer and/or a crank shaft angle sensor.

Optionally, the propulsor performance is airborne emissions. Optionally, the determining the airborne emissions of the first propulsor comprises obtaining information from a first exhaust gas monitoring system for sensing the mass of airborne emission(s) emitted from the first propulsor via an exhaust of the first propulsor. Optionally, the determining the airborne emissions of the second propulsor comprises obtaining information from a second exhaust gas monitoring system for sensing the mass of airborne emission(s) emitted from the second propulsor via an exhaust of the second propulsor.

Optionally, the method further comprises transmitting information indicative of the determined performance properties to a processor for determining a difference between the performance properties. In examples, the information is transmitted to a processor onboard the vessel, e.g. via a communication conduit communicatively connecting the controller and the processor. In examples, the determined performance properties are transmitted to a processor remote from the vessel, e.g. to a processor onshore. In these examples, the transmitting comprises, for example, communicating the information from the controller onboard the vessel to a transmitter onboard the vessel, transmission (e.g. satellite transmission) of the information from the transmitter to a receiver onshore or otherwise remote from the vessel, and communicating the information from the receiver to the processor which is communicatively connected to the receiver.

Optionally, the transmitting the information is performed at predetermined time intervals. For example, the method comprises transmitting the information at 10 minute intervals. Alternatively, the transmitting the information comprises continuously transmitting the information.

A fifth aspect of the present invention provides an apparatus configured to perform a method according to the fourth aspect.

Optionally, the apparatus comprises: the first propulsor; the second propulsor; one or more first performance property sensors for obtaining information indicative of the performance property of the first propulsor; one or more second performance property sensors for obtaining information indicative of the performance property of the second propulsor; and a processor for determining the performance properties of the first and second propulsors respectively.

Optionally, the apparatus further comprises a transmitter for transmitting information indicative of the performance properties of the first and second propulsors respectively.

Features described in relation to the fourth aspect are explicitly disclosed in combination with the fifth aspect, to the extent that they are compatible.

A sixth aspect of the present invention provides a vessel comprising an apparatus according to the second aspect, an apparatus according to the fifth aspect, and/or a non-transitory computer-readable storage medium according to the third aspect.

Features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

Embodiments of the invention will now be described, by way of example only, with reference to the accompanying drawings, in which:

FIG. 1 shows a schematic side view of an example of a marine vessel according to an embodiment of the present invention.

FIG. 2 shows a schematic view of an example apparatus for determining performance properties of propulsors of a vessel according to an embodiment of the present invention.

FIG. 3 shows a flow chart illustrating an example of a method for determining performance properties of propulsors of a vessel according to an embodiment of the present invention.

FIG. 4 shows a schematic view of an example apparatus for determining an effect of varying a propulsor characteristic on vessel propulsor performance according to an embodiment of the present invention.

FIG. 5 shows a flow chart illustrating an example of a method for determining an effect of varying a propulsor characteristic on vessel propulsor performance according to an embodiment of the present invention.

FIG. 6 shows a schematic view of an example computer-readable medium according to an embodiment of the present invention.

### DETAILED DESCRIPTION

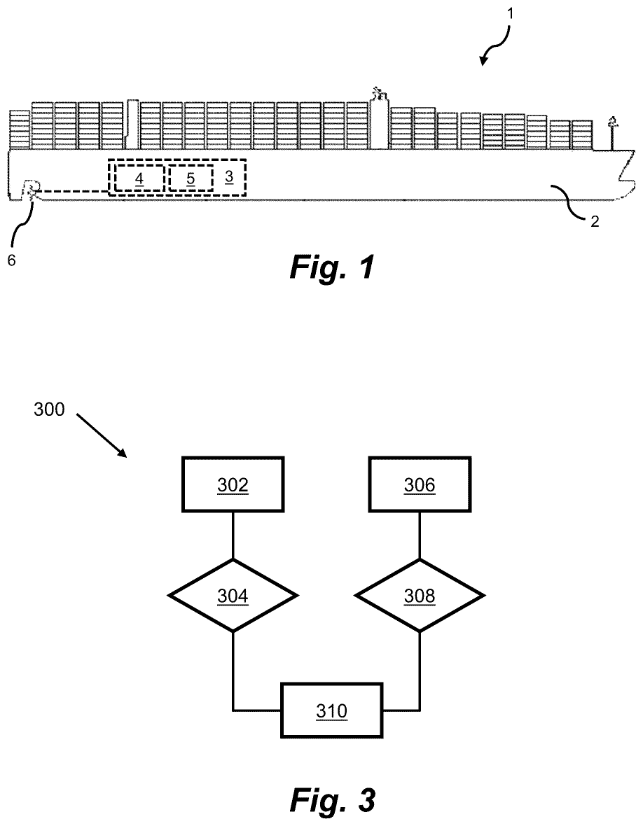

FIG. 1 shows a schematic side view of an example of a marine vessel according to an example. In this embodiment, the vessel is a container ship 1. In other embodiments, the marine vessel may be another form of cargo vessel, such as a tanker, a dry-bulk carrier or a reefer ship, or a passenger vessel or any other marine vessel.

The marine vessel 1 has a hull 2 and one or more engine rooms 3 inside the hull 2. The marine vessel 1 is powered by at least two internal combustion engines 4, 5, such as two-stroke self-igniting combustion engines 4, 5 located in an engine room 3. The engines 4, 5 drive a propulsion mechanism 6 (such as one or more propellers). The vessel 1 may also comprise one or more auxiliary engines (known as generator sets) that provide power and/or heat for various consumers of power aboard the vessel 1.

The engines 4, 5 are marine two-stroke crosshead internal combustion engines. In the example shown in FIG. 1, the engines 4, 5 are powered by marine heavy fuel oil. In other examples (not shown), the engines are powered by a fuel other than heavy fuel oil, such as marine light oil, marine diesel oil, marine gas oil, liquid natural gas, liquid petroleum gas, biofuel, methanol, ethanol, ammonia, hydrogen, methane, biomethane, or a combination thereof. In these examples, the fuel can be natural or synthetic. The engines 4, 5 are any suitable marine two-stroke crosshead internal combustion engines, such as diesel uniflow engines, or Otto cycle engines. The skilled person will be familiar with the components and systems of a marine vessel 1, and so further detailed discussion thereof is omitted for brevity.

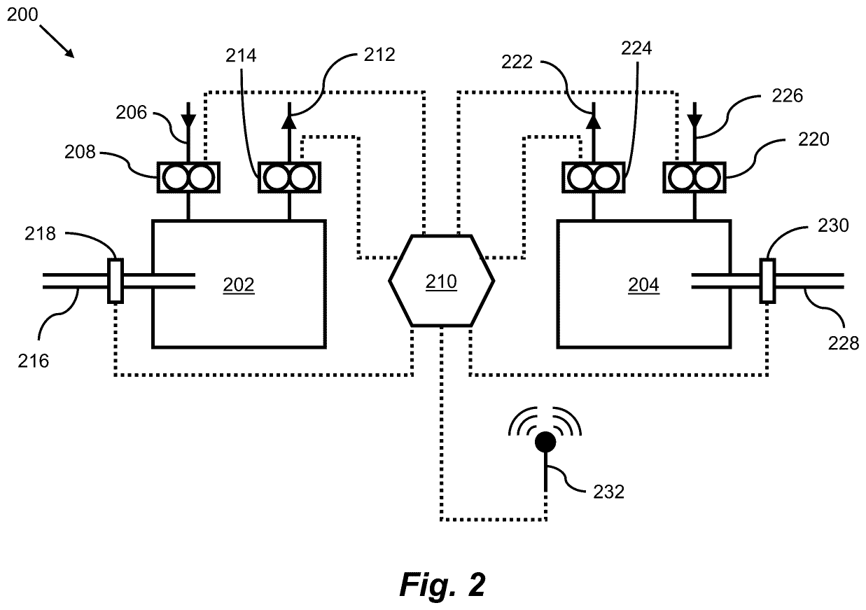

FIG. 2 shows a schematic view of an example apparatus 200 according to an embodiment of the present invention. The apparatus 200 depicted in FIG. 2 is for determining performance properties of propulsors of a vessel.

Communicative connectors for communicating information between components of the apparatus 200 are depicted in dashed lines.

The apparatus 200 comprises a first internal combustion engine 202 and a second internal combustion engine 204. In the apparatus 200 depicted in FIG. 2, the first internal combustion engine 202 and second internal combustion engine 204 correspond to the engines 4, 5, depicted in FIG. 1. That is, the apparatus is arranged onboard the vessel 1.

The engines 202, 204 are configured to be operated under the same operating conditions apart from a difference between engine characteristic variations. For example, the engines 202, 204 are configured to be operated under the same operating conditions, apart from the kinematic viscosities of the cylinder oils which are to be provided to each of the cylinders of the engines 202, 204 (not shown).

The first engine 202 is configured to receive fuel, such as heavy fuel oil, from a fuel tank (not shown) via fuel inlet conduit 206. Arranged along the fuel inlet conduit 206 between the fuel tank and the first engine 202 is a first inlet mass flowmeter 208 for sensing the mass of fuel delivered from the fuel tank to the first engine 202. The first inlet mass flowmeter 208 is communicatively connected to a controller 210 such that the controller 210 can obtain information indicative of the mass of fuel delivered to the first engine 202 during its operation.

Not all of the fuel delivered to the first engine 202 is necessarily consumed during operation of the first engine 202. Accordingly, the apparatus further comprises a fuel return conduit 212 along which the first engine 202 discharges unconsumed fuel to an overflow tank (not shown).

Arranged along the fuel return conduit 212 between the first engine 202 and the overflow tank is a first return mass flowmeter 214 for sensing the mass of fuel discharged from the first engine 202 to the overflow tank. The first return mass flowmeter 214 is communicatively connected to the controller 210 such that the controller can obtain information indicative of the mass of fuel discharged from the first engine 202 during its operation. The controller 210 is configured to determine the amount of fuel consumed by the first engine 202 during its operation by determining the difference between the information indicative of the mass of fuel delivered to the first engine 202 received from the first inlet mass flowmeter 208 and the information indicative of the mass of fuel discharged from the first engine 202 received from the first return mass flowmeter 214.

The first engine 202 comprises a crankshaft 216 for transferring motive energy (in the form of rotational energy) from the first engine 202 to a propellor (not shown). Arranged along the crankshaft 216 is a first shaft power meter 218 for sensing the power return of the first engine 202. The first shaft power meter 218 comprises a torquemeter and a tachometer.

The first shaft power meter 218 is communicatively connected to the controller 210 such that the controller 210 can obtain information indicative of the power return of the first engine 202 during its operation.

The second engine 204 is configured to receive fuel, such as heavy fuel oil, from a fuel tank (not shown) via fuel inlet conduit 226. Arranged along the fuel inlet conduit 226 between the fuel tank and the second engine 204 is a second inlet mass flowmeter 220 for sensing the mass of fuel delivered from the fuel tank to the second engine 204. The second inlet mass flowmeter 220 is communicatively connected to the controller 210 such that the controller 210 can obtain information indicative of the mass of fuel delivered to the second engine 204 during its operation.

The apparatus further comprises a fuel return conduit 222 along which the second engine 204 discharges unconsumed fuel to an overflow tank (not shown). Arranged along the fuel return conduit 222 between the second engine 204 and the overflow tank is a second return mass flowmeter 224 for sensing the mass of fuel discharged from the second engine 204 to the overflow tank. The second return mass flowmeter 224 is communicatively connected to the controller 210 such that the controller can obtain information indicative of the mass of fuel discharged from the second engine 204 during its operation.

The controller 210 is configured to determine the amount of fuel consumed by the second engine 204 during its operation by determining the difference between the information indicative of the mass of fuel delivered to the second engine 204 received from the second inlet mass flowmeter 220 and the information indicative of the mass of fuel discharged from the second engine 204 received from the second return mass flowmeter 224.

The second engine 204 comprises a crankshaft 228 for transferring motive energy (in the form of rotational energy) from the second engine 204 to a propellor (not shown). Arranged along the crankshaft 228 is a second shaft power meter 230 for sensing the power output of the second engine 204. The second shaft power meter 230 comprises a torquemeter and a tachometer.

The second shaft meter 230 is communicatively connected to the controller 210 such that the controller 210 can obtain information indicative of the power output of the second engine 204 during its engine.

The controller 210 is configured to determine, based on the information obtained from the flowmeters 208, 214, 220, 224 and shaft power meters 218, 230, the fuel efficiency of the first engine 202 and the fuel efficiency of the second engine 204.

The controller 210 is communicatively connected to a transmitter 232, suitably a satellite transmitter. The controller 210 and transmitter 232 are configured to transmit the determined fuel efficiencies of the first and second engines 202, 204 to a receiver located remote from the vessel.

FIG. 3 shows a flow chart illustrating an example of a method 300 according to an embodiment of the present invention. The example depicted in FIG. 3 is a method 300 for determining fuel efficiencies of internal combustion engines capable of being performed with the apparatus 200 depicted in FIG. 2. Where relevant, reference numerals of the apparatus 200 are referred to in the description of FIG. 3 to aid understanding.

The method 300 comprises operating 302 the first internal combustion engine 202 for a first time period with a first variation of an engine characteristic. In this example, the variation is a first kinematic viscosity of the cylinder oil delivered to the engine during the operation of the engine 202 for the first time period.

The method 300 further comprises determining 304 the fuel efficiency of the first engine 202 during the first time period. The determining 304 comprises obtaining information indicative of the mass of fuel consumed through operation of the first engine 202 over the first time period (e.g. the fuel delivered to the engine 202 less the fuel discharged from the engine 202) and information indicative of the power output of the first engine 202 over the first time period.

In this example, the determining is based on information relating to steady-state operation of the first engine only. For example, the first time period excludes periods of time wherein the first engine 202 is not operated under steady state conditions.

The method 300 further comprises operating 306 operating the second internal combustion engine 204, simultaneous with the first internal combustion engine 202, for the first time period with a second variation of an engine characteristic. In this example, the variation is a second kinematic viscosity of the cylinder oil delivered to the engine during the operation of the engine 204 for the second time period, wherein the second kinematic viscosity is different from the first kinematic viscosity.

The method 300 further comprises determining 308 the fuel efficiency of the second engine 204 during the first time period. The determining 308 comprises obtaining information indicative of the mass of fuel consumed through operation of the second engine 204 over the first time period (e.g. the fuel delivered to the engine 204 less the fuel discharged from the engine 204) and information indicative of the power output of the second engine 204 over the first time period.

The method 300 further comprises transmitting 310 information indicative of the fuel efficiency of the first engine 202 and the second engine 204 to a receiver located remotely from the vessel. The transmitting 310 is performed at 10 minute intervals.

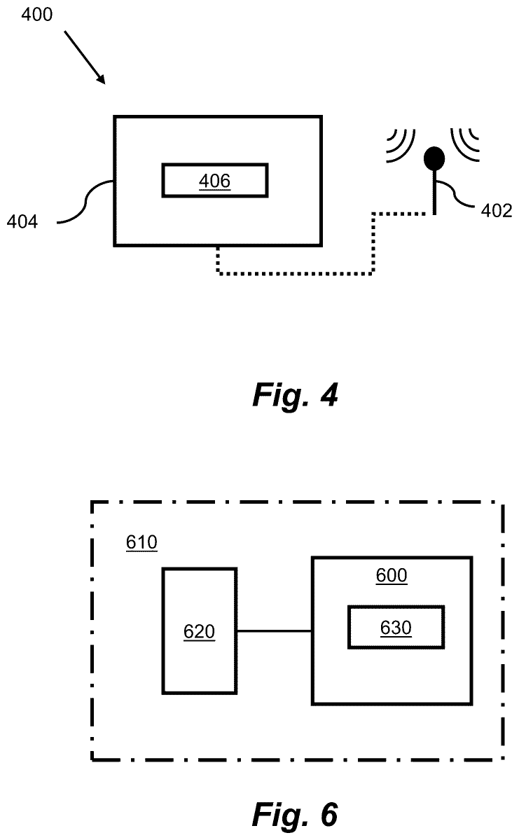

FIG. 4 shows a schematic view of an example apparatus 400 according to an embodiment of the present invention.

The apparatus 400 comprises a receiver 402 for receiving information indicative of the fuel efficiency of the first engine 202 and the second engine 204 during operation of the engines 202, 204 onboard the vessel 1. For example, the receiver 402 is configured to receive information from the transmitter 232 shown in FIG. 2.

The apparatus 400 further comprises a controller 404. The controller 404 is communicatively connected to the receiver 402 such that the controller 404 can obtain the received information indicative of the fuel efficiency of the first engine 202 and second engine 204.

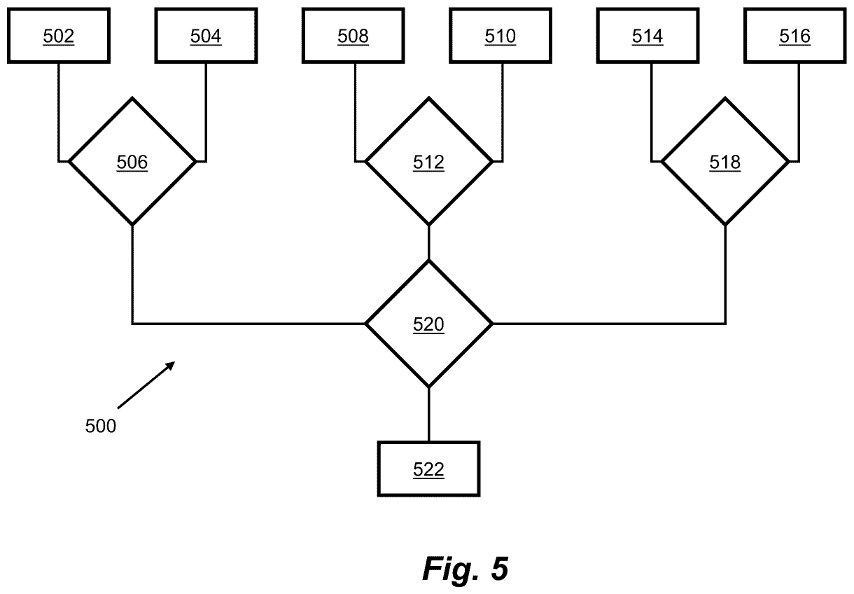

The controller 404 comprises a processor 406. The processor 406 is configured to perform the method 500 depicted in FIG. 5, described further hereinbelow.

FIG. 5 shows a flow chart illustrating an example of a method 500 according to another embodiment of the present invention. The method 500 depicted in FIG. 5 can suitably be performed with the apparatus 400 depicted in FIG. 4.

The method 500 depicted in FIG. 5 relates to determining a difference in fuel efficiency of engines. Other examples (not depicted) may instead relate to the determining of a difference between other propulsor performance properties such as airborne emission(s).

The method 500 comprises obtaining 502 information indicative of the fuel efficiency of the first engine 202 based on operation of the engine 202 for a first time period with a first variation of an engine characteristic. As noted above, in this example the first variation of the engine characteristic is a first kinematic viscosity of the cylinder oil delivered to the engine 202.

The method 500 further comprises obtaining 504 information indicative of the fuel efficiency of the second engine 204 based on operation of the engine 204, simultaneous with the first engine 202, for the first time period with a second variation of the engine characteristic. In this example, the second variation of the engine characteristic is a second kinematic viscosity of the cylinder oil delivered to the engine 204, the second kinematic viscosity different from the first.

The method 500 further comprises determining 506 a difference between the fuel efficiency of the first engine 202 whilst operated with cylinder oil having the first kinematic viscosity for the first time period, and the fuel efficiency of the second engine 204 whilst operated with cylinder oil having the second kinematic viscosity for the first time period.

The determining 506 comprises determining the normality and homoscedasticity of the obtained information, and determining the difference between the obtained information, and determining the statistical significance of the difference.

In some examples, the method 500 is concluded after the determining 506 the difference between fuel efficiencies during the first time period. However, the method 500 depicted in FIG. 5 represents an “ABA” test method.

The method 500 further comprises obtaining 508 information indicative of the fuel efficiency of the first engine 202 based on operation of the engine 202 for a second time period with the second variation of the engine characteristic. That is, during the second time period, the first engine 202 is operated using the cylinder oil having the second kinematic viscosity.

The method 500 further comprises obtaining 510 information indicative of the fuel efficiency of the second engine 204 based on operation of the engine 204, simultaneous with the first engine 202, for the second time period with the first variation of the engine characteristic. That is, during the second time period, the second engine 204 is operated using the cylinder oil having the first kinematic viscosity.

The method 500 further comprises determining 512 a difference between the fuel efficiency of the first engine 202 whilst operated with cylinder oil having the second kinematic viscosity for the second time period, and the fuel efficiency of the second engine 204 whilst operated with cylinder oil having the first kinematic viscosity for the second time period.

The determining 512 comprises determining the normality and homoscedasticity of the obtained information, and determining the difference between the obtained information, and determining the statistical significance of the difference.

The method 500 comprises obtaining 514 information indicative of the fuel efficiency of the first engine 202 based on operation of the engine 202 for a third time period with the first variation of an engine characteristic. That is, during the third time period, the first engine 202 is operated using the cylinder oil having the first kinematic viscosity (i.e. the same engine characteristic variation as employed during the first time period).

The method 500 further comprises obtaining 516 information indicative of the fuel efficiency of the second engine 204 based on operation of the engine 204, simultaneous with the first engine 202, for the third time period with a second variation of the engine characteristic. That is, during the third time period, the second engine 204 is operated using the cylinder oil having the second kinematic viscosity (i.e. the same engine characteristic variation as employed during the first time period).

The method 500 further comprises determining 518 a difference between the fuel efficiency of the first engine 202 whilst operated with cylinder oil having the first kinematic viscosity for the third time period, and the fuel efficiency of the second engine 204 whilst operated with cylinder oil having the second kinematic viscosity for the third time period.

The determining 518 comprises determining the normality and homoscedasticity of the obtained information, and determining the difference between the obtained information, and determining the statistical significance of the difference.

The method 500 further comprises determining 520 the average (mean) of the differences in fuel efficiencies from the first time period, the second time period, and the third time period. In calculating the mean difference, the modulus of the differences is used such that, for example, the determined difference during the second period does not negate the determined difference during the first period. Typically, the “ABA” test method 500 is capable of determining the difference in fuel efficiencies to an accuracy of 0.5%, or 0.1%, with statistical significance. In particular examples, each of the first time period, the second time period, and the third time period has a duration of at least 14 days, and the “ABA” test method 500 is capable of determining the difference in fuel efficiencies to an accuracy of 0.1% with statistical significance.

The method 500 further comprises attributing 522 the determined difference to the difference between the engine characteristic variation. For example, the method 500 comprises determining that the difference in fuel efficiency derives from the difference in kinematic viscosities between the cylinder oils employed.

FIG. 6 shows a schematic diagram of a non-transitory computer-readable storage medium 600 according to an example. The non-transitory computer-readable storage medium 600 stores instructions 630 that, if executed by a processor 620 of a controller 610, cause the processor 620 to perform a method according to an example. In examples, the instructions 630 comprise instructions to perform any example method described herein, such as the method 500 described above with reference to FIG. 5.

In other embodiments, two or more of the above described embodiments may be combined. In other embodiments, features of one embodiment may be combined with features of one or more other embodiments.

Example embodiments of the present invention have been discussed, with particular reference to the examples illustrated. However, it will be appreciated that variations and modifications may be made without departing from the scope of the invention as defined by the appended claims.

What is claimed is:

1. A method for determining an effect of varying a propulsor characteristic on vessel propulsor performance, the method comprising:
obtaining information indicative of a performance property of a first propulsor of a vessel based on operation of the first propulsor for a first time period with a first variation of the propulsor characteristic;
obtaining information indicative of the performance property of a second propulsor of the vessel based on operation of the second propulsor, simultaneous with the first propulsor, for the first time period with a second variation of the propulsor characteristic, wherein the second variation is different from the first variation; and
determining a difference between the performance property of the first propulsor and the performance property of the second propulsor.

2. The method of claim 1, further comprising:
obtaining information indicative of the performance property of the first propulsor of the vessel based on operation of the first propulsor for a second time period with the second variation of the propulsor characteristic;
obtaining information indicative of the performance property of the second propulsor of the vessel based on operation of the second propulsor, simultaneous with the first propulsor, for the second time period with the first variation of the propulsor characteristic; and
determining a difference between the performance property of the first propulsor during the second time period and the performance property of the second propulsor during the second time period.

3. The method of claim 2, further comprising:
obtaining information indicative of the performance property of the first propulsor of the vessel based on operation of the first propulsor for a third time period with the first variation of the propulsor characteristic;
obtaining information indicative of the performance property of the second propulsor of the vessel based on operation of the second propulsor, simultaneous with the first propulsor, for the third time period with the second variation of the propulsor characteristic; and
determining a difference between the performance property of the first propulsor during the third time period and the performance property of the second propulsor during the third time period.

4. The method of claim 1, wherein the performance property is efficiency of the propulsor.

5. The method of claim 1, wherein the propulsor characteristic is a fluid in the propulsor, a component of the propulsor, an operating parameter of the propulsor, a component of propulsor ancillary equipment, or an operation parameter of propulsor ancillary equipment.

6. The method of claim 1, wherein the first time period comprises one or more portions of time during which the first and second propulsors are operated under steady state.

7. The method of claim 1, wherein the performance property is a first performance property, and the method further comprises:
obtaining information indicative of a second performance property of the first propulsor based on operation of the first propulsor for the first time period with the first variation of the propulsor characteristic;
obtaining information indicative of the second performance property of the second propulsor based on operation of the second propulsor, simultaneous with the first propulsor, for the first time period with the second variation of the propulsor characteristic; and
determining a difference between the second performance property of the first propulsor and the second performance property of the second propulsor.

8. The method of claim 1, wherein each of the first propulsor and the second propulsor is an internal combustion engine.

9. A non-transitory computer-readable storage medium storing instructions that, if executed by a processor, cause the processor to:
obtain information indicative of a performance property of a first propulsor of a vessel based on operation of the first propulsor for a first time period with a first variation of the propulsor characteristic;
obtain information indicative of the performance property of a second propulsor of the vessel based on operation of the second propulsor, simultaneous with the first propulsor, for the first time period with a second variation of the propulsor characteristic, wherein the second variation is different from the first variation; and
determine a difference between the performance property of the first propulsor and the performance property of the second propulsor.

10. The method of claim 1, wherein the obtaining information indicative of the performance property of the first propulsor comprises:
operating the first propulsor of the vessel for the first time period with the first variation of a propulsor characteristic; and
determining the performance property of the first propulsor based on the operation of the first propulsor; and
the obtaining information indicative of the performance property of the second propulsor comprises:
operating the second propulsor of the vessel, simultaneous with the first propulsor, for the first time period with the second variation of the propulsor characteristic; and
determining the performance property of the second propulsor based on the operation of the second propulsor.

11. The method of claim 10, wherein the determining the performance property of the first propulsor and the determining the performance property of the second propulsor comprises obtaining information from one or more sensors for sensing the performance properties or for sensing properties corresponding to the performance properties.

12. The method of claim 10, wherein:
the performance property is fuel efficiency;
the determining the fuel efficiency of the first propulsor based on the operation of the first propulsor comprises:
obtaining information from a first indicator for determining the power output of the first propulsor,
obtaining information from a first inlet flowmeter for determining an amount of fuel supplied to the first propulsor, and optionally
obtaining information from a first return flowmeter for determining an amount of fuel discharged from the first propulsor,
and
the determining the fuel efficiency of the second propulsor based on operation of the second propulsor comprises:
obtaining information from a second indicator for determining the power output of the second propulsor,
obtaining information from a second inlet flowmeter for determining an amount of fuel supplied to the second propulsor, and optionally
obtaining information from a second return flowmeter for determining an amount of fuel discharged from the second propulsor.

13. An apparatus for determining an effect of varying a propulsor characteristic on vessel propulsor performance, the apparatus configured to:
obtain information indicative of a performance property of a first propulsor of a vessel based on operation of the first propulsor for a first time period with a first variation of the propulsor characteristic;
obtain information indicative of the performance property of a second propulsor of the vessel based on operation of the second propulsor, simultaneous with the first propulsor, for the first time period with a second variation of the propulsor characteristic, wherein the second variation is different from the first variation; and
determine a difference between the performance property of the first propulsor and the performance property of the second propulsor.

14. The apparatus according to claim 13, the apparatus further configured to:
operate the first propulsor of the vessel for the first time period with the first variation of a propulsor characteristic; and
operate the second propulsor of the vessel, simultaneous with the first propulsor, for the first time period with the second variation of the propulsor characteristic; and
the apparatus comprising:
the first propulsor;
the second propulsor;
one or more first performance property sensors for obtaining information indicative of the performance property of the first propulsor;
one or more second performance property sensors for obtaining information indicative of the performance property of the second propulsor; and
a processor for the determining the performance properties of the first and second propulsors respectively.
